(19) United States
(12) Patent Application Publication
(10) Pub. No.: US 2025/0326223 A1
(43) Pub. Date: Oct. 23, 2025

(54) METHODS OF FABRICATING REINFORCED ELASTOMER COMPOSITES AND REINFORCED ELASTOMER COMPOSITES FORMED THEREBY

(71) Applicant: Purdue Research Foundation, West Lafayette, IN (US)

(72) Inventor: Garam Kim, West Lafayette, IN (US)

(21) Appl. No.: 19/183,348

(22) Filed: Apr. 18, 2025

Related U.S. Application Data
(60) Provisional application No. 63/637,031, filed on Apr. 22, 2024.

(51) Int. Cl. B32B 43/00; B32B 27/18; B32B 27/30; B32B 27/38; B32B 37/06; B32B 37/18; B32B 37/26

(52) U.S. Cl. CPC B32B 43/006; B32B 27/18; B32B 27/306; B32B 27/38; B32B 37/06; B32B 37/18; B32B 37/26; B32B 2037/268; B32B 2262/106; B32B 2305/076; B32B 2305/74; B32B 2305/77; B32B 2307/7166; B32B 2329/04; B32B 2363/00

(57) ABSTRACT

Methods of fabricating reinforced elastomer composites and reinforced elastomer composites formed thereby. A sheet is fabricated of an elastomer with a reinforcing fiber encapsulated therein and a removable backing film attached to and covering an exterior surface of the sheet. The backing film is then dissolved with an aqueous solution to remove the backing film from the exterior surface of the sheet.

### CROSS-REFERENCE TO RELATED APPLICATIONS

This application claims the benefit of provisional U.S. Patent Application No. 63/637,031 filed Apr. 22, 2024, the contents of which are incorporated herein by reference

### BACKGROUND OF THE INVENTION

The present invention generally relates to reinforced elastomer composites, and more particularly to methods of fabricating reinforced elastomer composites and reinforced elastomer composites formed thereby.

Fiber-reinforced polymer composites are widely used in various industries, such as aerospace, automotive, maritime, and sporting goods due to many advantageous mechanical and physical properties. As the amount of composite material used in various industries has increased, the amount of composite waste has also increased, and the environmental sustainability of the composite has not been fully solved. End-of-life composite parts are often landfilled due to a lack of efficient recycling technology and high recycling costs. This can lead to environmental and economic damages. However, recycling composite materials is more challenging than recycling other materials, such as metal, plastic, or glass, due to the heterogeneous nature of the material. Once the fiber-reinforcement is impregnated with the matrix, the matrix needs to be either thermally decomposed or chemically dissolved to separate fiber-reinforcement from the matrix. The pyrolysis and solvolysis recycling processes require lots of energy and cost and are not environmentally friendly. For these reasons, mechanical recycling is most commonly used for fiber-reinforced composite parts.

Composite waste is generated not only from the end-of-life composite part but also from the composite part manufacturing process. Among many ways of composite part manufacturing technologies, the thermoset prepreg layup technique is one of the most commonly used. In this technique, sheets of prepreg are laid in stacks of plies (the “layup”) that are then laminated together with heat and pressure to form a desired three-dimensional component. “Prepreg” and “prepreg material” are terms commonly used in industry for a composite material formed of a framework of reinforcing fibers that are pre-impregnated with curable polymer matrix, such as a thermosetting epoxy resin, phenolic resin, or other curable resin, thermoplastic mixtures, or other curable elastomeric material. Some common frameworks of reinforcing fibers include carbon fibers, glass fibers, aramid fibers, which may be provided as flexible woven or nonwoven fabrics or simply or other frameworks that provide added tensile or other strength to the composite material. The curable polymer matrix is typically a thermoset elastomer provided in an uncured or partially cured state to allow the resin to be fully cured after the prepreg has been formed into the final desired shape. Prepregs typically are provided in sheets or rolls that have a tacky surface that needs to be covered with an easily removable backing film.

Prepreg material typically comes in roll form and it is often cut using an automatic cutting table to cut it into the designed ply shape for the layup. It is inevitable to have a leftover/waste prepreg material after the ply cutting process unless the ply has only a rectangular shape. The amount of prepreg leftover is heavily dependent on the shape of the ply and how the operator lays out the plies on the roll. Also, out-of-spec composite roll stock is a significant portion of composite waste from the composite part manufacturing process. The uncured prepreg is often designated as dangerous waste and requires special management when landfilled because it may generate toxic landfill gas and/or pollute soil and groundwater. Therefore, there have been many efforts to reduce uncured composite prepreg waste by reusing it for a new product. For example, some conventional techniques of reusing the uncured composite prepreg waste are to chop the uncured prepreg waste to make it into chip form and then use it for compression molding charge or sheet molding compound (SMC) roll form.

A significant challenge for reusing uncured prepreg waste is removing the backing film. Thermoset prepreg is a pre-impregnated composite material that is a combination of fiber reinforcement and thermoset polymer matrix. The thermoset polymer matrix in the material is partially cured which is called the “b-stage.” B-stage cured thermoset polymer is tacky, so the prepreg material can adhere to the layup tool for the composite part manufacturing process. Due to the adherence property of the prepreg, prepreg manufacturers attach a release backing film on either one or both sides of the material to keep it not to adhere to each layer when it comes with roll form. The release backing film is typically made of polyethylene film or silicone coated paper. The composite prepreg with the backing film is cut using an automatic cutting table, and the backing film is removed before it is laid on a composite part manufacturing tool. If the backing film were to remain inside of the laminate, it would hinder the layers from bonding with each other and cause delamination. In the same manner, it is important to make sure that there is no backing film in the uncured prepreg waste when it is reused to make a new product. Removing the backing film from the prepreg pieces is typically accomplished manually. However, this is a time and labor-intensive task. In addition, since the backing film on the uncured prepreg is removed manually, there is a chance of human error in the process. Also, there is no way to ensure that there is no backing left on the recycling prepreg. This can make it difficult to guarantee that a composite part made from recycled prepreg material has a consistent mechanical performance. Therefore, it is important to make sure there is no backing film while the material is reused because the backing film in the laminate can cause defects, such as delamination.

In view of the above, it would be desirable to be able to remove the backing film from a prepreg or other similar reinforced elastomeric composite easily with less need for manual labor and in a way that easily ensures complete removal of all the backing material.

### BRIEF SUMMARY OF THE INVENTION

The intent of this section of the specification is to briefly indicate the nature and substance of the invention, as opposed to an exhaustive statement of all subject matter and aspects of the invention. Therefore, while this section identifies subject matter recited in the claims, additional subject matter and aspects relating to the invention are set forth in other sections of the specification, particularly the detailed description, as well as any drawings.

The present invention provides, but is not limited to, methods of fabricating reinforced elastomer composites and reinforced elastomer composites produced thereby.

According to a nonlimiting aspect, a method of fabricating a reinforced elastomer composite is provided. The method includes fabricating a sheet of elastomer with a reinforcing fiber encapsulated therein and a removable backing film attached to and covering an exterior surface of the sheet. The backing film is dissolved with an aqueous solution to remove the backing film from the exterior surface of the sheet.

According to another nonlimiting aspect, a reinforced elastomer composite includes a sheet of elastomer, a reinforcing fiber encapsulated within the sheet of elastomer, and a backing film attached to an exterior surface of the sheet of elastomer. The backing film is water-soluble.

Technical aspects of methods and reinforced elastomer composites as described above preferably include the ability to make it easier and/or more cost effective to recycle fiber reinforced composite materials, such as prepreg materials, and thereby improve the environmental sustainability and/or reduce negative environmental impacts from disposing of such composite material wastes.

These and other aspects, arrangements, features, and/or technical effects will become apparent upon detailed inspection of the figures and the following description.

### BRIEF DESCRIPTION OF THE DRAWINGS

FIG. 1 is a schematic illustration of a process of fabricating and recycling a reinforced elastomer composite according to nonlimiting aspects of the present invention.

FIG. 2A is a schematic diagram of a process of recycling the aqueous PVA solution obtained in the process of FIG. 1 into a new/recycled PVA film.

FIG. 2B is an image of the recycled PVA film obtained from the process illustrated in FIG. 2A.

### DETAILED DESCRIPTION OF THE INVENTION

The intended purpose of the following detailed description of the invention and the phraseology and terminology employed therein is to describe one or more nonlimiting embodiments of the invention, and to describe certain but not all aspects of what is depicted in the drawings, including the embodiment(s) to which the drawings relate. The following detailed description also describes certain investigations relating to the embodiment(s) depicted in the drawings, and identifies certain but not all alternatives of the embodiment(s). As nonlimiting examples, the invention encompasses additional or alternative embodiments in which one or more features or aspects shown and/or described as part of a particular embodiment could be eliminated, and also encompasses additional or alternative embodiments that combine two or more features or aspects shown and/or described as part of different embodiments. Therefore, the appended claims, and not the detailed description, are intended to particularly point out subject matter regarded as aspects of the invention, including certain but not necessarily all of the aspects and alternatives described in the detailed description.

As used herein the terms “a” and “an” to introduce a feature are used as open-ended, inclusive terms to refer to at least one, or one or more of the features, and are not limited to only one such feature unless otherwise expressly indicated. Similarly, use of the term “the” in reference to a feature previously introduced using the term “a” or “an” does not thereafter limit the feature to only a single instance of such feature unless otherwise expressly indicated.

To provide an improved way to enable easier recycling/reuse of waste prepreg and other types of reinforced composite materials, the present invention uses a water-soluble backing film as a backing film for the prepreg, so that the backing film can be removed by soaking the prepreg in water when the prepreg is reused. Unless stated otherwise, the term “prepreg” is used in the following detailed description to refer to any reinforced elastomeric composite material that needs a backing film, including but not limited to conventional prepreg materials. Preferably the backing film is made of polyvinyl alcohol (PVA) film. In embodiments and investigations leading to the present invention, 20-micron thick 100% PVA film was used as a backing film for a carbon fiber reinforced thermoset prepreg. However, it is possible that other types and/or configurations of the water-soluble backing film may be used. The performance of the PVA film as a prepreg backing film was assessed, and the backing film removing process was demonstrated. To investigate how the backing film removing process affects mechanical properties of the reused prepreg, tensile and double cantilever beam (DCB) tests were performed and showed that the PVA backing removing process and drying process did not substantially negatively affect the tensile property and interlaminar strength of the reused composite laminate. These investigations also demonstrated the recycling of the PVA solution that was used for the PVA backing removing process to remake PVA film. Application of PVA backing film not only solved the backing film removing the issue of prepreg reusing process but also achieved sustainable closed-loop recycling of the prepreg backing film.

According to a nonlimiting aspect of the present invention, a polyvinyl alcohol (PVA) film may be used as a backing film for the prepreg material. PVA is a water-soluble synthetic polymer that is often used for laundry and dishwasher pods, embroidery stabilizers, and support material for 3D printing. PVA is also used as a release agent for the prepreg layup tooling surface in the composite part manufacturing process. The biggest challenge in uncured prepreg recycling, removing the backing film, can be solved by substituting a water-soluble PVA film for the conventional PE or Si-based backing film on prepreg material. If PVA film is used for prepreg backing film, the leftover prepreg can be soaked in water to remove the backing film, and only prepreg material will be left and ready to be recycled. In investigations leading to the present invention, the performance of the PVA film as a prepreg backing film was assessed, and the recycling process of the PVA film-backed prepreg was developed and demonstrated. Possible contamination on the prepreg due to the PVA backing film or during the recycling process was investigated. A nonlimiting optimal drying temperature for the embodiments used for the investigations was determined by studying the cure kinetics of the resin system in the prepreg material. Some studies showed a significant influence of moisture absorption on fiber reinforced polymer composite. If the moisture absorption affects the mechanical properties of the composite permanently, the mechanical properties of the recycled composite part will be degraded even if the recycled prepreg is properly dried. Therefore, tensile and double cantilever beam tests were performed with a laminate made with recycled prepreg to investigate how the recycling process affects the mechanical properties of the recycled composite.

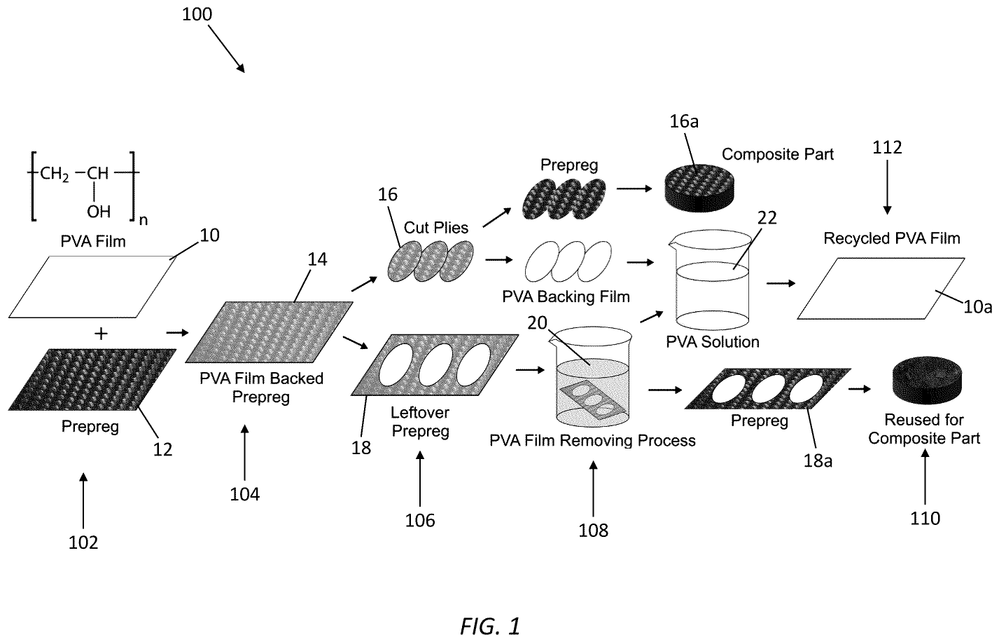

Turning now to the nonlimiting embodiments represented in the drawings, FIG. 1 depicts a schematic diagram of a method 100 of the PVA film application for the prepreg backing film and the PVA backing film removing process for the prepreg reusing process. At 102, a sheet of water-soluble backing film 10 is laminated onto the surface of a prepreg sheet 12 of fiber reinforced elastomer to form at 104 a prepreg blank sheet 14 made of the prepreg sheet 12 of fiber reinforced elastomer coated with the backing film 10. In this example, the backing film 10 is made of water-soluble PVA, although other types of water-soluble materials could be used. At 106, the blank sheet 14 may optionally be cut or otherwise formed into any number of various shapes for use in manufacturing a composite part, such as an aerospace or automotive component or any other desired component. This forming process results in the formation of work pieces 16 that will be used for fabricating the intended component(s) and leftover waste material pieces 18. At 108, the backing film 10 is removed from the work pieces 16 and/or from the waste material pieces 18 by dissolving the respective work pieces 16 and/or waste material pieces 18 with an aqueous solution, such as water. The dissolving process at 108 is preferably accomplished, for example, by soaking the respective work pieces 16 and/or waste material pieces 18 in a container filled with water 20 and/or spraying water onto the backing film 10 one or more times and/or for a selected period of time sufficient to dissolve all of the backing film 10 without negatively affecting the mechanical properties of the prepreg sheet 12 of fiber reinforced elastomer. As a nonlimiting example, the work pieces 16 and/or waste material pieces 18 can be soaked a plurality of times in a plurality of volumes of the aqueous solution such that the last volume of the aqueous solution is substantially free of any dissolved backing film material (e.g., dissolved PVA) in order to ensure that no or only de minimis amounts of dissolved backing film material remain on the surface of the prepreg sheet 12. The dissolving/cleaning process at 108 results in the formation of an aqueous PVA solution 22 and one or more cleaned work pieces 16a and/or cleaned waste pieces 18a from which the backing film 10 has been completely removed. Thereafter, at 110, the cleaned waste pieces 18a may optionally be reused/recycled into another prepreg sheet (e.g., 12), another composite part, or any other desired reuse/recycle form. In addition, at 112, the aqueous PVA solution 22 obtained from the dissolving process 108 optionally also may be reused/recycled, for example into a new/recycled PVA film 10a for reuse as a new backing film 10 or for any other desired used.

Certain nonlimiting methodologies and materials used in investigations leading to the present invention are discussed below to indicate various aspects of the invention as well as to evidence the effectiveness and usefulness of the methodologies and materials.

In the investigations, Axiom AX5201-FR carbon fiber reinforced epoxy prepreg was used for the prepreg sheet 12 of fiber-reinforced elastomer. Commercially available 20-micron thick 100% PVA embroidery stabilizer film was used as the water-soluble backing film 10. The original backing film on the prepreg was removed and the new PVA water-soluble backing film 10 was attached to both sides of the prepreg sheet 12. The PVA film-backed prepreg (e.g., blank sheet 14) was stored in a freezer for a week.

The performance of the PVA film as a prepreg backing film 10 was investigated. To substitute for a conventional prepreg backing film, the PVA water-soluble backing film 10 should stick and stay with prepreg sheet 12 to prevent the prepreg from sticking to each other. However, when the prepreg sheet 12 is laid on the layup tool, the backing film 10 needs to be removed easily without any residue left on the prepreg sheet 12. If there is any residue left on the surface of the prepreg, it can cause delamination that degrades the mechanical and physical properties of the resulting laminate made from plies of the prepreg sheet 12. The PVA film-backed prepreg 14 was cut into 50.8×50.8 mm squares 16 using an automatic cutting table. The PVA backing on the plies was removed and the surface of the prepreg was observed using a scanning electron microscope (SEM) to investigate any residue left on the surface. The plies of 50.8×50.8 mm square were then laid up and cured in an autoclave. The cured laminate was cut, and its cross-sectional area was observed using a microscope to investigate any evidence of defect, contamination, or delamination inside of the laminate.

To investigate the PVA film backing film removing process, the PVA film-backed prepreg was soaked in water to dissolve the PVA backing, and the cleaned prepreg was then dried in an oven to remove any moisture left inside of the prepreg. Square plies (50.8×50.8 mm) were soaked in distilled water for 1 minute. One group of plies was soaked without stirring and the other group was soaked and stirred using a paint mixer (100 rpm). The surfaces of the plies were observed using an SEM to investigate any PVA residue on the plies. Once the PVA film was dissolved in the water, the water became an aqueous PVA solution and the prepreg was exposed to the PVA solution. High-concentrated PVA solution on the prepreg ply can be detrimental when it is used to make a laminated component formed of several layers of the prepreg laminated together. PVA has a release property that hinders the plies from sticking to each other during the curing, which will degrade interlaminar strength and can cause delamination. To ensure the least amount of PVA solution was left on the plies, three different water soaking stages were prepared. In each stage, the plies were soaked in distilled water and stirred with the mixer for one minute (about 100 rpm). After each stage, the plies were observed using an SEM to investigate any PVA residue on the ply surface.

The plies needed to be fully dried before they were used for the layers in the laminated component (also, simply called the “laminate” herein). If there is any moisture inside the laminate during curing, the moisture expands at an elevated temperature and causes an air bubble (delamination) inside the laminate. Finding an optimal drying temperature and duration is important. The drying process should eliminate all the moisture in the prepreg. However, if the elastomer is a thermosetting material, the resin should not be cured during the drying process. If the resin gets cured during the drying process, the plies do not bond as well as possible in the laminate, and it degrades the interlaminar strength of the laminate. Different drying temperatures were tested using a differential scanning calorimeter (DSC) to investigate how much reaction occurs at each temperature. Four different drying temperatures were tested; 40° C., 60° C., 80° C., and 100° C. The DSC was set to ramp up to the drying temperature with a ramp rate of 10° C./min and soak at the drying temperature for two hours. The heat flow in the prepreg during the drying temperature was analyzed to determine an effective drying temperature. Once the drying temperature was determined, the drying duration was decided by measuring the weight change of the water-soaked prepreg at the drying temperature until it returned to its original weight.

The influence of the PVA backing film removing process on the mechanical properties of the reused laminate was also investigated because some literature reports that moisture degrades the mechanical properties of the fiber reinforcement in the composite permanently that is not recovered even after it is dried. Therefore, a tensile test, which is heavily affected by the fiber reinforcement, was performed. The tensile test specimen preparation and the tensile test were performed in accordance with ASTM 3039, Standard Test Method for Tensile Properties of Polymer Matrix Composite Materials. The influence of the PVA residue on the prepreg, moisture exposition, and the drying process on the interlaminar bonding strength of the reused prepreg was investigated using the double cantilever beam (DCB) test. The DCB test specimen preparation and DCB test were performed in accordance with ASTM D5528, Standard Test Method for Mode I Interlaminar Fracture Toughness of Unidirectional Fiber-Reinforced Polymer Matrix Composites. The Tensile and DCB test specimens were made using two different materials; reused prepreg that went through the PVA backing film removing process, and prepreg with the traditional backing film. The test results were analyzed and compared to find how the PVA backing film removing process affects the tensile and interlaminar strength of the laminate.

Investigations of the performance of the PVA film as the prepreg backing film showed that The PVA film adhered to the prepreg and stayed well on the prepreg material. The PVA backing film could be removed by picking up the corner of the film using a utility knife gently and peeling it by hand. An SEM image of the PVA film-backed prepreg (e.g., blank sheet 14) showed no evidence of PVA residue or contaminant on the ply surface and no difference compared to the prepreg with the traditional backing film after the PVA film was peeled. SEM images of the cross-sectional area of the cured laminates made of twelve plies ([0]12 orientation) of the traditional backed prepreg and the PVA film-backed prepreg 14 showed that there is no evidence of PVA residue, contaminants, or voids inside of the laminates made therefrom. Overall, the PVA film met all the desired characteristics for the prepreg backing film.

To remove the PVA film, the backed prepregs were soaked in the distilled water 22 for one minute, as illustrated at 108. An SEM image of the ply that was soaked without stirring showed melted PVA remained on the ply surface. However, an SEM image of the ply soaked with stirring showed no PVA residue on the surface of the ply. The SEM images showed that stirring helped completely remove the PVA backing film on the prepreg sheet. However, if the rotational speed of the mixer was too high, the fiber on the edge of the prepreg sheet was pulled. Therefore, it was important to use the proper mixer design and its rotational speed to prevent damage to the prepreg sheet. The backed prepreg (e.g., 16 or 18) went through three different water soaking stages with stirring. SEM images of the prepreg after the first soaking stage did not show any noticeable PVA residue on the prepreg surface, and there was no significant difference compared to SEM image of the prepreg after the second and third water soaking stages. It was shown that most of the PVA film was washed out in the first water soaking stage. However, the water used in the first soaking stage became a highly concentrated PVA solution (e.g., 22) and the prepreg which was exposed to the PVA solution could have a degraded interlaminar bonding strength. Therefore, multiple soaking stages (e.g., three stages) were used when the mechanical test specimens were made even though the SEM image showed no distinctive PVA residue on the ply surface after the first soaking stage. A cross-sectional microscopic image of the laminate made of PVA film-backed prepreg that went through three water soaking stages and dried did not show any air bubble, delamination, contamination in the laminate.

To rapidly remove moisture from the surface of the prepreg after the dissolving process 108, the cleaned prepregs optionally may be actively dried, for example by heating and/or with forced air. When using heat drying, an optimal drying temperature should be high enough to eliminate all the moisture in the prepreg and low enough not to cure the resin in the prepreg. The prepreg material was inserted in the DSC to measure heat flow from the sample during the different drying temperatures; 40° C., 60° C., 80° C., and 100° C. The DSC result at the 100° C. drying cycle showed a large heat flow hump that was caused by the reaction during the curing. Within two hours, most of the reaction had occurred, and the heat flow had decreased close to the plateau. The DSC result during the 80° C. drying cycle did not show a heat flow hump, but the heat flow kept increasing which meant more reaction was occurring during the drying cycle. The DSC result of the 60° C. and 40° C. drying cycles did not show a distinctive heat flow change. To determine the drying duration that was long enough to eliminate all the moisture inside of the prepreg, the weight of the prepreg before and after the soaking period was measured. The drying duration that was needed to allow the prepreg to return to its original weight at each drying temperature was measured. The result showed that the moisture is fully dried in less than 10 minutes at all the drying temperatures. Therefore, a drying temperature of 60° C. was used, which did not cause significant resin curing, for 10 minutes, which is long enough to remove all the moisture inside of the prepreg, for the drying process.

The prepreg plies that went through the PVA backing film removing process (e.g., 108), including three water soaking stages and the drying process, were prepared and laid to make tensile and DCB test specimens. The tensile test specimen was made of eight plies thick laminate with [0]8 ply orientation (about 1.68 mm thick), and the DCB test specimen was made of 16 plies thick laminate with [0]16 ply orientation (about 3.06 mm thick). The laminate was cured using an autoclave at 121° C. for 2 hours with 90 psi. The cured laminate was cut into the test specimen size using a surface grinder. The size of the tensile test specimen was 25.4×254 mm, and the size of the DCB test specimen was 25.4×304.8 mm. On the tensile test specimen, tabs were bonded both sides on each end to prevent any damage from the test fixture gripping during the tensile test. The DCB test specimens had a pre-made crack that was inserted during the layup process. Steel piano hinges were bonded on each side of the test specimen.

For the tensile test, eight reused PVA film-backed test specimens and eight control test specimens that were made of the traditional prepreg were prepared and tested. An MTS universal testing machine with a 2 mm/min tensile rate was used for the test. The tensile load data was collected from a load cell on the MTS machine, and the strain of the test specimen was measured using a Digital Image Correlation (DIC) technology. The stress was calculated by dividing the load data by the cross-sectional area of the test specimen. Once stress and strain were obtained, ultimate tensile strength and tensile modulus of elasticity for each test specimen were found. The average ultimate tensile strength of reused PVA film-backed prepreg test specimen was 757 MPa and the average ultimate tensile strength of the traditional prepreg specimen was 685 MPa. The reused prepreg test specimen showed about 11% higher ultimate tensile strength compared to the traditional prepreg test specimen. The average tensile modulus of the reused PVA film-backed prepreg test specimen was 63 GPa and the average tensile modulus of the traditional prepreg specimen was 62 GPa. There was no significant difference in the average tensile modulus between the reused PVA film-backed prepreg test specimen and the traditional prepreg test specimen. The tensile test result did not show any evidence of tensile property degradation of the reused PVA film-backed prepreg test specimen. It was found that the PVA backing film removing process 108 did not degrade the tensile property of the laminate in this study.

For the DCB test, five reused and five control DCB test specimens were prepared and tested. The hinges attached to the DCB test specimens were gripped to the MTS machine and pulled with a 5 mm/min rate. When the crack propagated, the machine was unloaded and went back to the original position. For each test specimen, four load/unload cycles were performed. Load, displacement, and crack length were measured to find Mode I interlaminar fracture toughness ( ) of the test specimens. Modified Beam Theory method was used to calculate as shown in the following equation;

$$G\_Ic = 3 P δ / 2 b a , \qquad Eq ( 1 )$$

where P represents load, δ represents displacement, b represents width of the DCB test specimen, and a represents delamination length. The testing showed that the average G_Ic of the reused prepreg test specimens was 669 J/m2 and the average G_Ic of the traditional prepreg test specimens was 585 J/m2. The testing also showed that the average G1c of the reused test specimens was greater than the average G1c of the traditional test specimens. The DCB test result did not show any evidence of interlaminar strength degradation (Mode I fracture toughness) of the reused PVA film-backed prepreg test specimens. These tests showed that the PVA backing film removing process 108 did not degrade the interlaminar bonding strength of the laminate in this study.

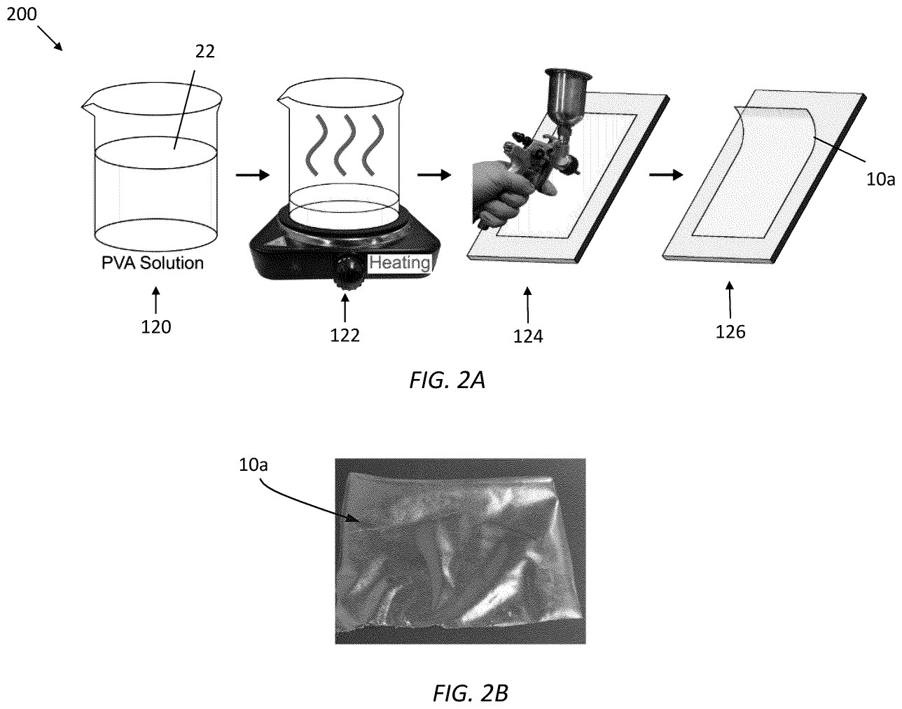

Turning now to FIG. 2A, in another set of tests, a nonlimiting example method 200 of recycling/reusing the aqueous PVA solution 22 was investigated. The PVA solution 22 was filtered to remove any contamination in the solution 22 and the solution 22 was heated to increase the PVA concentration in the solution 22. The solution 22 was sprayed on a caul plate, and the remade PVA film was collected once it was dried. In this nonlimiting example, at 120 the aqueous PVA solution 22 that was used to remove the PVA backing film in the PVA film removing process 108 is collected into a container. The PVA solution 22 was filtered using a paper filter to remove any torn carbon fiber and contaminants inside the solution 22. Then at 122, the filtered PVA solution 22 was heated to evaporate the water to increase the PVA concentration in the solution 22. When the desired PVA concentration was achieved, at 124, the high-concentrated PVA solution 22 was sprayed onto a caul plate using a spray gun and allowed to dry. After the solution 22 was fully dried, the PVA film on the caul plate, at 126, the dried PVA film 10a was collected from the plate. FIG. 2B is an image of a PVA film 10a obtained from the process represented in FIG. 2A. The collected PVA film 10a was about 20-micron thick. Optionally, the PVA film 10a can be reused as a backing film 10 for another prepreg sheet 12 as described previously herein. Thus, both the PVA solution that was used for the backing film removing process as well as the leftover uncured prepreg can be reused/recycled. to achieve full closed-loop sustainability of the PVA film-backed prepreg material with zero waste.

When the uncured thermoset prepreg (e.g., 18A) is reused, the backing film 10 is preferably completely removed from the prepreg to prevent any damage to the composite part made of reused prepreg. From these investigations, it can be seen that the method 100 of using a water-soluble PVA film 10 as a release backing film for prepreg facilitates the backing film removing process for reusing/recycling uncured prepreg material. The application of the PVA film 10 for fiber reinforced thermoset composite prepreg backing film and the PVA backing removing process by soaking the prepreg in the water were demonstrated as viable methods of effectively and easily recycling/reusing the prepreg material and/or the aqueous PVA solution obtained from the dissolving/removal process.

The PVA film 10 effectively prevented the prepregs from sticking to each other, and it could be easily removed from the prepreg when it was used for a layup. The PVA backing film was removed by soaking the PVA film-backed prepreg in water and stirring using a mixer. Most of the PVA film was removed in the first water soaking stage. However, due to any potential non-visible PVA residue or PVA solution inside of the laminate, three different water soaking stages were used for the rest of the research. There was no evidence of PVA residue or contaminant left on the prepreg after the PVA film was removed. The drying temperature and duration were investigated using a DSC to find a suitable drying temperature that dried all the moisture in the plies, but that did not cure the resin. Tensile and DCB tests did not show any evidence of tensile and interlaminar bonding strength (Mode I interlaminar fracture toughness) degradation of the reused composite part. Full closed-loop sustainability of PVA backing film was achieved by also recycling the PVA solution that was used to remove the PVA film to remake the PVA film.

Along with the increased amount of usage of fiber reinforced polymer composite material in various industries, people pay a lot of attention to the sustainability of the composite material. The majority of the research related to composite sustainability is recycling EOL composite parts by extracting the fibers using mechanical, chemical, or thermal methods. However, uncured prepreg is still taking a great portion of the composite wastes, and there is a lot of potential sustainability promotion through reusing the uncured prepreg wastes. The methods 100 and 200 disclosed herein provide a new approach to the composite sustainability problem and showed another potential way of promoting sustainability of the composite material.

As previously noted above, though the foregoing detailed description describes certain aspects of one or more particular embodiments of the invention, alternatives could be adopted by one skilled in the art. For example, the methods and composites and their components could differ in appearance and construction from the embodiments described herein and shown in the drawings, functions of certain components of the methods and composites could be performed by components of different construction but capable of a similar (though not necessarily equivalent) function, and various materials could be used in the methods and the fabrication of composites and/or their components. As such, and again as was previously noted, it should be understood that the invention is not necessarily limited to any particular embodiment described herein or illustrated in the drawings.

1. A method of fabricating a reinforced elastomer composite, the method comprising:
fabricating a sheet of elastomer with a reinforcing fiber encapsulated therein and a removable backing film attached to and covering an exterior surface of the sheet; and
dissolving the backing film with an aqueous solution to remove the backing film from the exterior surface of the sheet.

2. The method of claim 1, wherein the backing film comprises water-soluble polyvinyl alcohol.

3. The method of claim 1, wherein the backing film consists of water-soluble polyvinyl alcohol.

4. The method of claim 1, wherein the step of dissolving comprises soaking the reinforced elastomer composite in water.

5. The method of claim 4, wherein the step of dissolving comprises soaking the reinforced elastomer composite sequentially in at least a first amount of water and a second amount of water, wherein the second amount of water does not contain any PVA prior to the soaking.

6. The method of claim 1, wherein the step of dissolving comprises spraying an amount of water onto the backing film to dissolve and remove the backing film from the exterior surface of the sheet.

7. The method of claim 1, further comprising reusing the sheet of elastomer after the backing film has been removed by dissolving to fabricate a laminate.

8. The method of claim 1, wherein the reinforcing fiber is a carbon fiber.

9. The method of claim 1, wherein the sheet of elastomer with a reinforcing fiber is a thermoset prepreg.

10. The method of claim 1, further comprising reusing the aqueous solution containing dissolved material of the backing film to fabricate a new backing film.

11. A reinforced elastomer composite comprising:
a sheet of elastomer;
a reinforcing fiber encapsulated within the sheet of elastomer; and
a backing film attached to an exterior surface of the sheet of elastomer, wherein the backing film is water-soluble.

12. The reinforced elastomeric composite of claim 11, wherein the backing film comprises polyvinyl alcohol.

13. The reinforced elastomeric composite of claim 12, wherein the backing film consists of polyvinyl alcohol.

14. The reinforced elastomeric composite of claim 11, wherein the reinforcing fiber comprises one or more carbon fibers.

15. The reinforced elastomeric composite of claim 11, wherein the elastomer comprises a thermoset polymer matrix.

16. The reinforced elastomeric composite of claim 11, wherein sheet of elastomer and reinforcing fibers comprise a prepreg sheet.

17. The reinforced elastomeric composite of claim 11, wherein the elastomer is a heat curable elastomer that is uncured or at most partly cured.
